(19) United States
(12) Patent Application Publication
(10) Pub. No.: US 2015/0277412 A1
(43) Pub. Date: Oct. 1, 2015

(54) METHOD FOR THE FUNCTIONAL EXTENSION OF AN ELECTRIC WELDING APPARATUS AND WELDING APPARATUS FOR CARRYING OUT THE METHOD

(71) Applicant: Lorch Schweisstechnik GmbH, Auenwald (DE)

(72) Inventor: Josef Goeppert, Kusterdingen (DE)

(21) Appl. No.: 14/645,510

(22) Filed: Mar. 12, 2015

(30) Foreign Application Priority Data
Mar. 26, 2014 (DE) 10 2014 104 227

(51) Int. Cl. G05B 19/042

(52) U.S. Cl. CPC G05B 19/0426; G05B 2219/45135

(57) ABSTRACT

A method for extending the functionality of an electric welding apparatus having a programmable control unit and an input device is provided. In order to provide the user with greater latitude for a desired functional extension while nevertheless ensuring that unauthorized functional extension can be prevented, a control command for a desired functional extension is issued to the control unit and the control unit uses the control command or the functional extension to generate an apparatus code which is transmitted to an external verifying facility. The external verifying facility uses the apparatus code to verify entitlement to the functional extension and, if entitlement exists, generates an external activation code which is transmitted to the control unit. The control unit then verifies the validity of the external activation code and, if it is valid, implements the functional extension. A welding apparatus for carrying out the method is also proposed.

This application claims the benefit of German application number 10 2014 104 227.1 filed on Mar. 26, 2014, which is incorporated herein by reference in its entirety and for all purposes.

### BACKGROUND OF THE INVENTION

The invention relates to a method for extending the functionality of an electric welding apparatus which comprises a programmable control unit and an input device.

The invention moreover relates to an electric welding apparatus for carrying out the method, the welding apparatus comprising a programmable control unit and the functionality of the welding apparatus being extendable, and the welding apparatus comprising an input device.

Electric welding apparatuses for electric welding of a workpiece conventionally comprise a control unit, a power supply and a welding torch with a welding electrode connectable to the power supply. Between the welding electrode and the workpiece to be welded, an arc is generated, the action of which produces a weld seam. The power supply provides the electric welding voltage and current which are necessary for this purpose. The control unit controls the power supply and conventionally comprises an input device and a display device. The input device comprises operating elements for operating the welding apparatus and a user can conventionally read the prevailing welding parameters from the display device. In many cases, the welding apparatus additionally comprises a wire feeder which is frequently likewise controlled by the control unit and feeds welding material in the form of a welding wire to the welding torch.

Various welding programs may be stored in the control unit, for example for carrying out different welding methods and/or for welding different workpieces.

Users of such welding apparatuses have frequently acquired them to perform very specific welding tasks. It may, however, happen that a user would subsequently like to perform further welding tasks which are beyond the capabilities of the functionality initially predetermined by the manufacturer of the welding apparatus. It is then possible for the user to extend the functionality of the welding apparatus, for example by having further operating options or being provided with further welding programs. Functional extension may also consist in enabling an interface of the welding apparatus so that automation systems or additional apparatus may be connected to the welding apparatus. The interface may also be enabled in order to make it possible to read out and document welding parameters which are available for performing a specific welding task from the control unit contactlessly or with contact.

Software may be used for functional extension. The user may purchase the software for example from the manufacturer of the welding apparatus. The software may be stored on a storage medium readable by the control unit and, once the software has been read into the control unit, the latter can perform the desired functional extension of the welding apparatus.

The software producer can implement technical measures to prevent unauthorized copying in order to prevent unauthorized duplication of the software. However, this restricts use of the software to such an extent that even an authorized user cannot produce any copies. The software can also be password protected, such that it can only be used by an authorized person who knows the password. However, an authorized person can pass on the password to unauthorized third parties who are thus in turn able to use the software outside the producer's control.

It may be provided that the software can only be activated or used within a specific period of time. This gives rise to the difficulty that an authorized user must already be aware of the desired period of activation at the time of purchasing the software, such that software of this kind cannot straightforwardly be used on an ad hoc basis.

It is also possible to restrict use of the software to very specific welding apparatuses, which the user defines on the basis of their serial numbers at the time of purchasing the software. In this case, however, a user must indicate which specific welding apparatuses the software is to be used for at the time of purchasing the software. This is very troublesome and largely impractical.

The object of the present invention is to provide a method of the above general type which provides an authorized user with greater latitude for functional extension while nevertheless preventing unauthorized functional extension.

### SUMMARY OF THE INVENTION

According to the invention, said object is achieved in a method of the initially stated type in that a control command for a desired functional extension is issued to the control unit and, using the control command and/or the desired functional extension, the control unit generates an apparatus code which is transmitted to an external verifying facility, wherein the external verifying facility uses the apparatus code to verify entitlement to the functional extension and, if entitlement exists, generates an external activation code which is transmitted to the control unit, and wherein the control unit verifies the validity of the external activation code and, if it is valid, implements the functional extension.

The user thus has the possibility of issuing a control command for a desired functional extension to the control unit and entitlement to the functional extension is verified by the control unit interacting with an external verifying facility. If an entitlement does exist, the control unit can implement the functional extension. For the purposes of verifying entitlement, the control unit uses the input control command and/or the functional extension associated with the control command to generate an apparatus code. The apparatus code is transmitted to an external verifying facility. The external verifying facility uses the apparatus code generated by the control unit to verify entitlement to the functional extension. The external verifying facility is thus able on the basis of the apparatus code to distinguish an authorized functional extension from an unauthorized functional extension. If entitlement exists, the external verifying facility generates an external activation code which is transmitted to the control unit of the welding apparatus. The control unit verifies the validity of the external activation code. If the control unit establishes that the transmitted external activation code is valid, said code serves as entitlement to the functional extension for the control unit, so that it can then implement the functional extension. The method according to the invention can be carried out very simply without the welding apparatus having to be permanently linked to a computer network and connected to a computer.

Verification of the entitlement to carry out a functional extension is carried out twice. On the one hand, the external verifying facility verifies a corresponding entitlement on the basis of an apparatus code which the external verifying facility receives from the control unit of a specific welding apparatus. A further entitlement verification is then carried out by the control unit, the latter making use of the external activation code generated by the external verifying facility to verify entitlement. It is thus possible to ensure in a structurally simple manner that only those control units can carry out a functional extension which, on the basis of an apparatus code they have generated, have obtained an apparatus-specific external activation code from the external verifying facility.

It may be provided that the control command which is issued to the control unit by the user contains an identification number which characterizes a desired functional extension. The identification number may be used by the control unit for generating the apparatus code, for example the identification number may be encoded.

Alternatively or in addition to the identification number, the control unit may also make use of other data or information for generating the apparatus code, for example a process number which characterizes a specific functional extension process which is under way on the respective welding apparatus. As will be explained in greater detail below, it is for example also possible to use an apparatus identification which unambiguously identifies the welding apparatus and/or information which characterizes the configuration of the respective welding apparatus for generating the apparatus code.

In an advantageous embodiment of the method according to the invention, an encryption algorithm which makes use of the apparatus code is used for generating the external activation code. Suitable encryption algorithms are known to a person skilled in the art and therefore require no further explanation here.

It may also be provided that the apparatus code includes several items of information and only one or more items of information which the apparatus code includes are encrypted by the external verifying facility for generating the external activation code. It may for example be provided that the apparatus code contains an identification number which characterizes a specific functional extension and that the identification number is encrypted for generating the external activation code. As has already been explained, the apparatus code may for example also contain a process number which the control unit of the welding apparatus has used for generating the apparatus code, and said process number may encrypted for generating the external activation code.

It may also be provided that the control unit uses a random item of information, for example a random number, generated by the control unit for generating the apparatus code. The random item of information may be extracted from the apparatus code by the external verifying facility and be encrypted for generating the external activation code.

The validity of the external activation code may be verified by comparison with an internal activation code generated by the control unit. It is for example possible for the control unit to encrypt information or data, which it has used for generating the apparatus code, in the same manner as the external verifying facility in order to generate an internal activation code. The validity of the external activation code may then be verified by the control unit in that the latter compares the internal activation code it has generated with the external activation code generated by the external verifying facility. If the internal activation code is identical to the external activation code, entitlement to the functional extension exists and the control unit can implement the functional extension.

It is advantageous for the external verifying facility to determine the functional extension and/or an identification number which characterizes the functional extension by decoding the apparatus code.

The external verifying facility can recognize on the basis of the apparatus code which specific functional extension is desired and can then verify whether an entitlement to this functional extension exists.

If an entitlement does exist, the external verifying facility can generate the external activation code. If an entitlement does not exist, the external verifying facility can reject the request.

In order to verify entitlement, the external verifying facility can verify the existence of an entitlement stored in a database for the functional extension determined from the decoded apparatus code or the identification number determined from the decoded apparatus code. It may for example be provided that, at the time of purchasing a functional extension, entitlement data are stored in a database which can be accessed by the verifying facility. At the time of purchasing the functional extension, there is no need for the user to state either which specific welding apparatus the functional extension is intended for or the time at which he/she would like to implement the functional extension. If the user then inputs a control command for the desired functional extension to a specific welding apparatus, the control unit generates the apparatus code, preferably using the functional extension or an identification number which characterizes the functional extension. The external verifying facility can then extract the desired functional extension or the identification number corresponding thereto from the apparatus code and compare it with data stored in the database in order to verify whether an entitlement exists. If an entitlement does exist, the verifying facility can use the extracted data to generate an external activation code, on the basis of which the control unit can then recognize the entitlement and thereupon implement the functional extension.

The external verifying facility data preferably stores the data which correspond to the functional extension or identification number determined from the decoded apparatus code in a database, so that these data may be retrieved at any later point in time. It may also be provided that the external verifying facility deletes the data corresponding to the functional extension or the identification number from the database or locks them in the database. This makes it possible in a structurally simple manner to use the information determined from the decoded apparatus code only once, such that a functional extension of a welding apparatus can be carried out only once on the basis of this information. If the external verifying facility receives the same data at a later point in time by transmission of an apparatus code, the data can no longer be compared with data stored in the database and the external verifying facility can then reject a request for a functional extension. The data may also be locked in the database if, for example, the user loses the identification number or the identification number is stolen from him/her. As will be explained in greater detail below, the identification number or also other entitlement data may be stored on a storage medium and, in the event of loss or theft, the identification number or other entitlement data may be locked in the database, so preventing unauthorized use.

In one particularly preferred embodiment of the method according to the invention, data and/or a software program relating to the functional extension may be input into the control unit together with the control command. In the case of such a development of the method according to the invention, the user may not only input a control command for a desired functional extension into the control unit but also has the option to input other data and/or a software program together with the control command. In particular, it may be provided that a software program which enables the desired functional extension is input together with the control command. It may also be provided that corresponding software programs have already been stored in a storage element of the control unit by the manufacturer of the welding apparatus on the manufacturer's premises. If the user desires a functional extension, the user may issue a corresponding control command to the control unit and, if entitlement exists, the control unit then reads the software program from the storage element to carry out the functional extension.

The control command may be stored for example on a storage medium which can be read by the control unit contactlessly or with contact. Correspondingly, an identification number which characterizes the functional extension and/or further data and/or at least one software program for the functional extension may be stored on a storage medium which can be read by the control unit contactlessly or with contact. The storage medium may be for example a memory card, a USB stick, a memory chip, an RFID tag or an NFC tag. Memory cards in particular are generally known and used in daily life for various purposes. They can be produced inexpensively in large numbers and also be used for the method according to the invention.

If the functional extension is to be carried out, the storage medium may be read, in particular a control command stored on the storage medium and/or a software program for the functional extension may be read out.

In an advantageous embodiment of the method according to the invention, the control command, the identification number, the data and/or software programs for the functional extension are transmitted by a computer or a mobile telecommunication device which are connected contactlessly or with contact in signal-conducting manner with the control device, for example via a serial connection, Ethernet, USB, Bluetooth or NFC. Using a mobile telecommunication device, for example a mobile telephone, is in particular advantageous because such devices are in any event available to the user for other purposes and these devices may now also be used for the functional extension of welding apparatuses.

It may for example be provided that the control command, the identification number, the data and/or software programs for the functional extension be transmitted by the user's mobile telephone. The user can download a software program for the functional extension over the internet from a database and transmit it to the control unit of the welding apparatus. The control unit recognizes a control command in the transmission and then carries out the entitlement verification in cooperation with the external verifying facility.

As has already been mentioned, it is favourable for the apparatus code to contain an apparatus identification which unambiguously identifies the welding apparatus or to be generated using an apparatus identification which unambiguously identifies the welding apparatus. The serial number of the welding apparatus may, for example, be used as the apparatus identification.

It may also be provided that the apparatus code contains information which characterizes the configuration of the welding apparatus or is generated using such information. This information may be extracted from the apparatus code by the external verifying facility and for example stored in a database and/or compared with corresponding information stored in a database.

It is advantageous for the apparatus code to be visually or graphically displayed on a display device of the welding apparatus. After inputting a control command for carrying out a functional extension, the user can visually or graphically acquire the apparatus code on the display device of the welding apparatus and then transmit the apparatus code to the external verifying facility. Graphical display of the apparatus code is particularly advantageous because this provides the user with the possibility of acquiring the apparatus code contactlessly by means of a sensor of a mobile telecommunication device, in particular a mobile telephone, or a computer and to transmit it from the mobile telecommunication device or computer to the external verifying facility. A camera may, for example, be used as the sensor.

Advantageously, the apparatus code is displayed on the display device of the welding apparatus in the form of a “QR” (Quick Response) code which can be acquired by the camera of a mobile telephone or another telecommunication device, wherein, in addition to the apparatus code, the QR code may also comprise telecommunication data for establishing a connection with the external verifying facility. The connection between the telecommunication device and the external verifying facility may, for example, be made over the internet, wherein, in addition to the apparatus code generated by the control unit, the QR code may contain the internet address of the external verifying facility.

In an advantageous embodiment of the method according to the invention, the external activation code generated by the external verifying facility is input into the control unit via the input device. It may, for example, be provided that the user inputs the external activation code manually. It is advantageous for the external activation code to be transmitted by the user to the input device of the welding apparatus via a mobile telephone, another mobile telecommunication device or a computer.

The apparatus code is favourably transmitted to the external verifying facility via a communication line or wirelessly.

The apparatus code and/or the external activation code are preferably transmitted via a mobile telecommunication device, for example in the form of an SMS (short message service) message.

It may be provided that the external activation code can be used only once. Thus, if a user, after a first functional extension of a welding apparatus, again inputs the external activation code into the same or another welding apparatus, the activation code does not give rise to another functional extension.

It is favourable for the period of use of the functional extension or the activation period for the functional extension to be time-limited. This makes it possible for the manufacturer to sell time-limited functional extensions or functional extensions which may only proceed within a specific period. It may, for example, be provided that a specific functional extension can only be used for a period of some hours, days or weeks after a first activation. As a result, it is possible for the user to make use of specific welding programs which constitute a functional extension for only a predetermined period. Once this period has elapsed, the functional extension must be purchased again from the manufacturer. It may also be provided that a specific functional extension can only be activated within a specific period. The activated functional extension may then possibly be used by the user for an unlimited period, but the activation itself must take place within a specific period.

A server connected to a database is advantageously used as the external verifying facility. Such servers are known per se to a person skilled in the art and therefore require no further explanation here.

As was initially mentioned, the invention relates not only to a method for extending the functionality of an electric welding apparatus but also to a welding apparatus for carrying out the method. To this end, according to the invention a welding apparatus is proposed which comprises a programmable control unit and is designed such that the functionality of the welding apparatus can be extended, the welding apparatus comprising an input device and a code generation device for generating an apparatus code and a verifying element for verifying the validity of a functional extension on the basis of an external activation code which can be input into the verifying element. As has already been mentioned, once a control command has been issued, an apparatus code which can be transmitted to an external verifying facility may be generated by means of the code generation device. If an entitlement to a functional extension does exist, the verifying facility transmits an external activation code to the control unit and the verifying element of the welding apparatus verifies the validity of the functional extension on the basis of the external activation code.

In an advantageous embodiment of the welding apparatus according to the invention, the code generation device comprises an encoding element for generating the apparatus code.

The welding apparatus preferably comprises an encryption element for generating an internal activation code. This makes it possible for the verifying element to compare the internal activation code with the external activation code generated by the external verifying facility.

It is advantageous for an identification number together with an apparatus identification specific to the welding apparatus to be encodable by the code generation device for generating the apparatus code. As has already been mentioned, the identification number characterizes a functional extension. The control command which may be input into the control unit favourably contains the identification number, such that the latter may be input into the code generation device via the input device of the welding apparatus.

The identification number and the apparatus identification specific to the welding apparatus may not only be used for generating the apparatus code, but may additionally also be used for generating an internal activation code which can be compared with the external activation code.

The following description of preferred embodiments of the invention serves, in conjunction with the drawings, to explain the invention in greater detail.

### BRIEF DESCRIPTION OF THE DRAWINGS

FIG. 1: is a schematic diagram of two advantageous embodiments of welding apparatuses according to the invention, the functionality of which may be extended by interaction with an external verifying facility; and

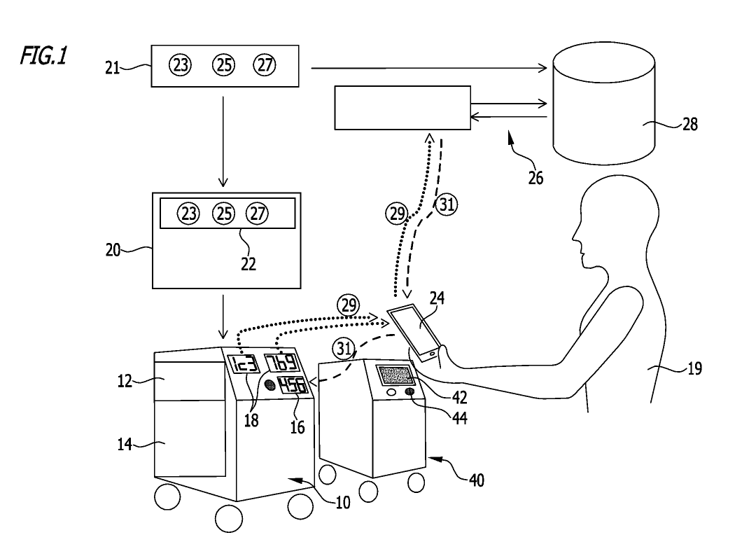

FIG. 2: illustrates individual method steps for extending the functionality of the welding apparatuses shown in FIG. 1.

### DETAILED DESCRIPTION OF THE INVENTION

The drawing is a schematic illustration of a first advantageous embodiment of a welding apparatus according to the invention, designated overall with reference numeral 10. The welding apparatus 10 comprises a control unit 12 and a power supply 14, which is controlled by the control unit 12 and to which a welding torch may conventionally be connected in a manner known per se, for which reason, and to ensure clarity of the drawing, it is not shown. The welding apparatus 10 moreover comprises an input device 16 for inputting control commands and software programs and a display device 18. In the exemplary embodiment shown, the display device 18 comprises a plurality of 7-segment displays.

Various welding tasks may be performed in conventional manner by a user 19 by means of the welding apparatus 10. The functionality of the welding apparatus 10 may be extended by the user 19. To this end, in the exemplary embodiment shown, the user 19 may purchase a storage medium in the form of a memory card 20 which can be read contactlessly or with contact by the input device 16. The memory card 20 comprises a storage element 22, in which a control command 23 for carrying out a functional extension and a corresponding software program 25 for the functional extension and an identification number 27 which characterizes the functional extension have been stored by a memory card programmer 21 for example on the premises of the welding apparatus manufacturer. This information was furthermore stored in a database 28 of an external verifying facility 26.

After reading the memory card 20, the control unit 12 of the welding apparatus 10 generates an apparatus code 29 which is displayed on the display device 18. Inter alia, the identification number 27, which is encoded and stored in the storage element 22, is used for generating the apparatus code 29.

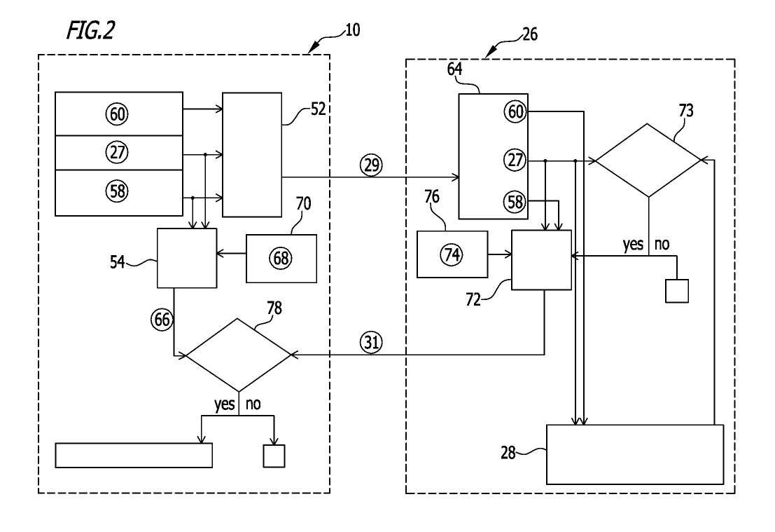

The user 19 can transmit the apparatus code 29 displayed on the display device 18 via a mobile telecommunication device, for example via a mobile telephone 24, to the external verifying facility 26, which decodes the apparatus code 29 and, on the basis of the extracted identification number 27, verifies entitlement to the functional extension. The external verifying facility 26 refers for this purpose to the data which were stored in a database 28. If the external verifying facility 26 recognizes that an entitlement to a functional extension does exist, the external verifying facility generates an external activation code 31, which is transmitted to the mobile telephone 24 and displayed to the user 19 on the screen of the mobile telephone 24. The user 19 can then input the external activation code 31 to the control unit 12 via the input device 16. The control unit 12 verifies the validity of the external activation code 31 and optionally carries out the functional extension. The method according to the invention for functional extension is explained in greater detail below with reference to FIG. 2.

Instead of a welding apparatus 10 with a display device 18, on which the apparatus code is displayed to the user for manual input into the mobile telephone 24, it is also possible to use a welding apparatus 40 which is of largely identical design to the previously explained welding apparatus 10. The welding apparatus 40 differs from the welding apparatus 10 by a display device 42, on which the apparatus code is graphically displayed to the user together with an internet address in the form of a QR code. The QR code can be contactlessly acquired by a camera of the mobile telephone 24 and the displayed internet address may be looked up by means of the mobile telephone 24, via which internet address the mobile telephone 24 can be connected with the external verifying facility 26 for transmission of the apparatus code 29 graphically displayed on the display device 42. If an entitlement to the functional extension does exist, the external activation code 31 may be transmitted to the mobile telephone 24 and graphically displayed on the screen thereof, likewise in the form of a QR code. A camera 44 on the welding apparatus 40 can contactlessly acquire the external activation code 31 displayed on the screen of the mobile telephone 24 and, if the external activation code 31 is valid, the desired functional extension can be carried out by the control unit of the welding apparatus 40.

As is apparent from FIG. 2, the welding apparatus 10, like the welding apparatus 40, has a code generation device with an encoding element 52 and an encryption element 54. The identification number 27 stored in the storage element 22 of the memory card 20 and a process number 58 generated by the control unit 12 and favourably also additional information 60, such as for example an apparatus identification which unambiguously characterizes the welding apparatus 10 or the welding apparatus 40 and/or information which characterizes the configuration of the welding apparatus 10 or the welding apparatus 40 may be input into the encoding element 52. The encoding element 52 encodes the identification number 27, the process number 58 and the additional information 60 and generates the apparatus code 29, which is transmitted to a decoding element 64 of the external verifying facility 26. The identification number 27 and the process number 58 are furthermore input into the encryption element 54 which generates an internal activation code 66 using the identification number 27 and the process number 58. To this end, the encryption element 54 carries out encryption with the assistance of secret information 68 which is stored in a storage element 70 of the control unit 12.

The apparatus code 29 is decoded by the decoding element 64 of the external verifying facility 26 and the identification number 27, the process number 58 and the additional information 60 are extracted from the decoded apparatus code. In the exemplary embodiment shown, the additional information 60 and the identification number 27 are stored in the database 28 of the external verifying facility 26 and the identification number 27 is compared by a verifying element 73 of the external verifying facility 26 with the identification numbers stored in the database 28. As has already been mentioned, the identification number 27 stored on the storage element 22 of the memory card 20 was stored in the database 28, such that the identification number extracted from the apparatus code 29 can simply be compared with the identification number stored in the database 28.

If the identification number 27 contained in the apparatus code 29 matches an identification number stored in the database 28, then an entitlement to the desired functional extension does exist. As a consequence, the external activation code 31 is generated by an encryption element 72 of the external verifying facility 26 with the assistance of an encryption algorithm and is transmitted to the control unit 12. The external activation code 31 is generated by encrypting the identification number 27 and the process number 58, which were extracted from the decoded apparatus code 29, in the same manner as they were by the encryption element 54 of the control unit 12. The encryption element 72 of the external verifying facility 26 uses secret information 74 which is stored in a storage element 76 of the external verifying facility 26 for encryption. The external activation code 31 is thus identical to the internal activation code 66 which was produced by the encryption element 54.

The external activation code 31 is transmitted to a verifying element 78 of the control unit 12 and compared by the latter with the internal activation code 66. If the two codes are identical, the desired functional extension is carried out and displayed to the user on the display device 18 or on the display device 42. If the codes are nonidentical, performance of a functional extension is refused and refusal is displayed to the user on the display device 18 or on the display device 42.

If the identification number 27 contained in the apparatus code 29 does not match an identification number stored in the database 28, no entitlement to the desired functional extension exists and the verifying element 73 refuses the functional extension.

It may be provided that the identification number 27 only provides entitlement to a functional extension for a particular period. To this end, the time at which the apparatus code 29 containing the identification number 27 is received by the external verifying facility 26 is compared with an entitlement period stored in the database 28. If the receive time is within the entitlement period, the external activation code 31 is transmitted. If the receive time is outside the entitlement period, no external activation code is generated and the request for the functional extension is rejected.

It may also be provided that a functional extension may only be used for a predetermined period of use. To this end, the control unit 12 may comprise a timer which records the period of use and, once a maximum period of use has elapsed, turns the functional extension back off.

1. A method for extending the functionality of an electric welding apparatus which comprises a programmable control unit and an input device, wherein a control command for a desired functional extension is issued to the control unit and, using at least one of the control command and the functional extension, the control unit generates an apparatus code which is transmitted to an external verifying facility, wherein the external verifying facility uses the apparatus code to verify entitlement to the functional extension and, if entitlement exists, generates an external activation code which is transmitted to the control unit, and wherein the control unit verifies the validity of the external activation code and, if it is valid, implements the functional extension.

2. A method according to claim 1, wherein the control command contains an identification number which characterizes the desired functional extension and the identification number is used for generating the apparatus code.

3. A method according to claim 2, wherein the identification number is encoded for generating the apparatus code.

4. A method according to claim 2, wherein an encryption algorithm which makes use of the apparatus code or the identification number is used for generating the external activation code.

5. A method according to claim 1, wherein the validity of the external activation code is verified by comparing it with an internal activation code generated by the control unit.

6. A method according to claim 2, wherein the external verifying facility determines the functional extension or the identification number by decoding the apparatus code.

7. A method according to claim 6, wherein the external verifying facility verifies the functional extension or identification number determined from the decoded apparatus code for the existence of an entitlement stored in a database and, depending on the existence of the entitlement, generates the external activation code or rejects the request.

8. A method according to claim 6, wherein the external verifying facility stores data which correspond to the functional extension or identification number determined from the decoded apparatus code in a database or deletes or locks identical data in the database.

9. A method according to claim 1, wherein, together with the control command, at least one of data and a software program for the functional extension is input into the control unit.

10. A method according to claim 1, wherein the control command is stored on a storage medium which is readable by the control unit contactlessly or with contact.

11. A method according to claim 2, wherein at least one of the control command and the identification number is stored on a storage medium which is readable by the control unit contactlessly or with contact.

12. A method according to claim 9, wherein at least one of the control command, the data and the software program for the functional extension is stored on a storage medium which is readable by the control unit contactlessly or with contact.

13. A method according to claim 2, wherein, together with the control command, at least one of data and a software program for the functional extension is input into the control unit, and wherein at least one of the control command, the identification number, the data and the software program for the functional extension is stored on a storage medium which is readable by the control unit contactlessly or with contact.

14. A method according to claim 1, wherein the control command is transmitted by a computer or a mobile telecommunication device which are connected contactlessly or with contact in signal-transmitting manner with the control device.

15. A method according to claim 2, wherein at least one of the control command and the identification number is transmitted by a computer or a mobile telecommunication device which are connected contactlessly or with contact in signal-transmitting manner with the control device.

16. A method according to claim 9, wherein at least one of the control command, the data and the software program for the functional extension is transmitted by a computer or a mobile telecommunication device which are connected contactlessly or with contact in signal-transmitting manner with the control device.

17. A method according to claim 2, wherein, together with the control command, at least one of data and a software program for the functional extension is input into the control unit, and wherein at least one of the control command, the identification number, the data and the software program for the functional extension is transmitted by a computer or a mobile telecommunication device which are connected contactlessly or with contact in signal-transmitting manner with the control device.

18. A method according to claim 1, wherein the apparatus code contains an apparatus identification which unambiguously identifies the welding apparatus or is generated using said apparatus identification.

19. A method according to claim 1, wherein the apparatus code contains information which characterizes the configuration of the welding apparatus or is generated using said information.

20. A method according to claim 1, wherein the apparatus code is displayed visually or graphically on a display device of the welding apparatus.

21. A method according to claim 1, wherein the external activation code is transmitted to the control unit via the input device.

22. A method according to claim 1, wherein the apparatus code is transmitted to the external verifying facility via a communication line or wirelessly.

23. A method according to claim 1, wherein at least one of the apparatus code and the external activation code is transmitted via a mobile telecommunication device.

24. A method according to claim 1, wherein the external activation code is usable only once.

25. A method according to claim 1, wherein at least one of the period of use of the functional extension and the activation period of the functional extension is time-limited.

26. A method according to claim 1, wherein a server connected to a database is used as the external verifying facility.

27. A welding apparatus for carrying out the method according to claim 1, the welding apparatus comprising a programmable control unit and the functionality of the welding apparatus being extendable, and the welding apparatus comprising an input device, a code generation device for generating an apparatus code and a verifying element for verifying entitlement to a functional extension on the basis of an external activation code which is configured to be input into the verifying element.

28. A welding apparatus according to claim 27, wherein the code generation device comprises an encoding element and wherein the welding apparatus comprises an encryption element for generating an internal activation code.

29. A welding apparatus according to claim 28, wherein an identification number, which characterizes a functional extension and is configured to be input into the encoding element via the input device, is encodable, together with an apparatus identification specific to the welding apparatus, by means of the encoding element for generating the apparatus code.
